(19) United States
(12) Patent Application Publication
(10) Pub. No.: US 2007/0018363 A1
(43) Pub. Date: Jan. 25, 2007

(54) Methods of aligning mold and articles

(75) Inventor: Thomas R.J. Corrigan, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/185,097

(22) Filed: Jul. 20, 2005

(51) Int. Cl. B29C 33/40; B29C 35/08; B29C 59/02

(52) U.S. Cl. 264/496; 264/320; 264/219; 264/293; 425/215; 425/403

(57) ABSTRACT

Methods of aligning flexible molds, segmented mold and frame apparatus, as well as methods of making microstructured articles (e.g. PDP back panels) are described.

### BACKGROUND

Advancements in display technology, including the development of plasma display panels (PDPs) and plasma addressed liquid crystal (PALC) displays, have led to an interest in forming electrically-insulating barrier ribs on glass substrates. The barrier ribs separate cells in which an inert gas can be excited by an electric field applied between opposing electrodes. The gas discharge emits ultraviolet (UV) radiation within the cell. In the case of PDPs, the interior of the cell is coated with a phosphor that gives off red, green, or blue visible light when excited by UV radiation. The size of the cells determines the size of the picture elements (pixels) in the display. PDPs and PALC displays can be used, for example, as the displays for high definition televisions (HDTV) or other digital electronic display devices.

U.S. Pat. No. 6,247,986 describes a method for molding and aligning microstructures on a patterned substrate using a microstructured mold. A slurry containing a mixture of a ceramic powder and a curable fugitive binder is placed between the microstructured surface of a stretchable mold and a patterned substrate. The mold can be stretched to align the microstructure of the mold with a predetermined portion of the patterned substrate. The slurry is hardened between the mold and the substrate. The mold is then removed to leave microstructures adhered to the substrate and aligned with the pattern of the substrate. The microstructures can be thermally heated to remove the binder and optimally fired to sinter the ceramic powder.

Although various molds and methods of aligning microstructures such as barrier ribs have been described, industry would find advantage in improvements.

### SUMMARY OF THE INVENTION

In one embodiment, the invention relates to a method of aligning a mold comprising providing a flexible mold having a microstructured surface and independently stretching one portion of the mold relative to a different portion of the mold to align the microstructured surface.

In one embodiment, the invention relates to a method of aligning a mold comprising providing a flexible mold having a microstructured surface in an apparatus wherein the mold, the apparatus, or a combination thereof comprises relief regions.

In another embodiment, the invention relates to a segmented mold comprised of a polymeric material, having at least one microstructured surface and a plurality of relief regions. The relief regions are typically provided at peripheral portions of a center mold region. The relief regions may comprise voided areas, slits, areas of reduced thickness, and combinations thereof.

In another embodiment, the invention relates to a frame apparatus attached to at least two peripheral portions of a center mold regions of a microstructured mold wherein the frame apparatus comprises segments and one segment can move independently relative to a different segment. The first peripheral portion may be parallel or orthogonal to the second edge. Preferably, the frame apparatus comprises at least one segment per 100 mm to 500 mm of the periphery.

For each of the described methods, the mold is typically aligned with a patterned substrate such as an electrode patterned glass panel. Each portion of the mold is preferably stretched in a first axis and a second axis, substantially orthogonal to the first axis. The mold may have a positioning error ranging from 10 ppm to 1000 ppm prior to stretching. The aligned mold typically has a positioning error of less than 10 ppm.

In other embodiments, the invention relates to methods of making a microstructured article comprising aligning the microstructured surface of the mold as previously described, placing a curable material between the microstructured surface of the mold and the patterned substrate either prior to or after stretching the mold, curing the curable material, and removing the mold. The mold is typically transparent. The curable material may be radiation cured through the patterned substrate, though the mold, or a combination thereof.

In each of the described embodiments, the mold may correspond in size to a single display panel. The mold may have an area ranging from about 1 cm² to about 2 m². The mold may be a portion of a sheet or roll. The mold and/or frame apparatus may be a polygon (e.g. square, octagon) rectangular, or circular.

### BRIEF DESCRIPTION OF THE DRAWINGS

FIG. 1 is a schematic representation of a plasma display panel assembly.

FIG. 2 is a schematic representation of aligning a flexible mold.

FIG. 3 is a planar view of an exemplary segmented mold.

FIG. 4 is a planar view of another exemplary segmented mold.

FIG. 5 is a schematic representation of an exemplary frame apparatus.

FIG. 6 is a schematic representation of an exemplary segmented frame apparatus.

FIG. 7 is a plan view of a portion of the segmented frame apparatus of FIG. 6.

FIG. 7a is a cross section of 7a of FIG. 7.

FIG. 7b is a cross section of 7b of FIG. 7.

### DETAILED DESCRIPTION OF PREFERRED EMBODIMENTS

The present invention relates to methods of aligning flexible molds, molds, apparatuses for aligning molds, as well as methods of making microstructured articles (e.g. PDP back panels). In particular, the present invention is directed to methods and molds suitable for making glass or ceramic microstructures on a substrate. While the present invention is not so limited, an appreciation of various aspects of the invention will be gained through a discussion of molds and methods suitable for the manufacture of barrier ribs for PDPs.

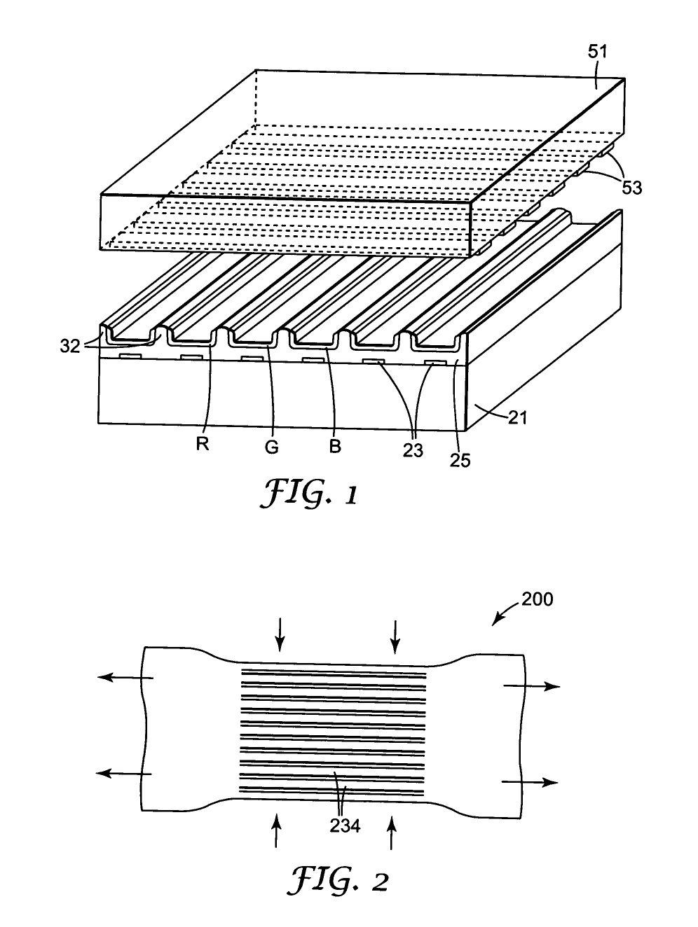

Plasma display panels (PDPs) have various components, as illustrated in FIG. 1. The back substrate, oriented away from the viewer, has independently addressable parallel electrodes 23. The back substrate 21 can be formed from a variety of compositions, for example, glass. Ceramic microstructures 25 are formed on the back substrate 21 and include barrier rib portions 32 that are positioned between electrodes 23 and separate areas in which red (R), green (G), and blue (B) phosphors are deposited. The front substrate includes a glass substrate 51 and a set of independently addressable parallel electrodes 53. These front electrodes 53, also called sustain electrodes, are oriented perpendicular to the back electrodes 23, also referred to as address electrodes. In a completed display, the area between the front and back substrate elements is filled with an inert gas. To light up a pixel, an electric field is applied between crossed sustain electrodes 53 and address electrodes 23 with enough strength to excite the inert gas atoms therebetween. The excited inert gas atoms emit ultraviolet (UV) radiation that causes the phosphor to emit red, green, or blue visible light.

Back substrate 21 is preferably a transparent glass substrate. Typically, for PDP applications back substrate 21 is made of soda lime glass. Front substrate 51 is typically a transparent glass substrate which preferably has the same or about the same coefficient of thermal expansion as that of the back substrate 21. Electrodes 23, 53 are strips of conductive material. The electrodes 23 are formed of a conductive material such as, for example, copper, aluminum, or a silver-containing conductive frit. The electrodes can also be a transparent conductive material, such as indium tin oxide, especially in cases where it is desirable to have a transparent display panel. The electrodes are patterned on back substrate 21 and front substrate 51. For example, the electrodes can be formed as parallel strips spaced about 120 μm to 360 μm apart, having widths of about 50 μm to 75 μm, thicknesses of about 2 μm to 15 μm, and lengths that span the entire active display area which can range from a few centimeters to several tens of centimeters. In some instances the widths of the electrodes 23, 53 can be narrower than 50 μm or wider than 75 μm, depending on the architecture of the microstructures 25.

The microstructured surface of the mold for making a microstructured article such as back substrate 21 typically comprises a plurality of recesses that create a parallel rib pattern, grid (i.e. lattice) pattern, or other pattern. The height, pitch and width of the microstructured barrier ribs portions 32 in PDPs can vary depending on the desired finished article. The height of the barrier ribs is generally at least 100 μm and typically at least 150 μm. Further, the height is typically no greater than 500 μm and typically less than 300 μm. The pitch of the barrier rib pattern may be different in the longitudinal direction in comparison to the transverse direction. The pitch is generally at least 100 μm and typically at least 200 μm. The pitch is typically no greater than 600 μm and typically less than 400 μm. The width of the barrier rib pattern 4 may be different between the upper surface and the lower surface, particularly when the barrier ribs thus formed are tapered. The width is generally at least 10 μm, and typically at least 50 μm. Further, the width is generally no greater than 100 μm and typically less than 80 μm.

The mold has two opposing major surfaces, at least one of which is a microstructured surface. The opposing surface is typically a generally planar, unstructured surface. The microstructured surface of the mold has a plurality of microstructures that represents the reverse structure of the microstructures to be formed and aligned on the patterned substrate. The mold can be made by compression molding of a thermoplastic material using a (e.g. metal) master tool that has a microstructured pattern. The mold can also be made of a curable material that is cast and cured onto a thin, flexible polymer film.

The alignment of a mold having a microstructured surface with a patterned substrate can be accomplished using various techniques that comprise positioning at least a portion of the microstructured surface. The mold prior to alignment may have a positioning error of greater than 10 parts per million (i.e. ppm, 10 microns of error over a 1 meter distance). Typically, the positioning error can range as high as 100, 1000 or 10,000 parts per million. After alignment, the positioning error is less than 10 parts per million. As used herein “positioning error” refers to the maximum deviation of a feature or point from its actual position to its desired position. In repeating structures at a particular pitch the error between any two adjacent structures is typically small. However, the cumulative error can be substantially greater.

The mold is preferably sufficiently flexible such that the aligning of the microstructured surface of the mold and the pattern of the substrate can be achieved by stretching the mold in at least one direction. By so stretching the mold for alignment, the mold can be corrected for mold or substrate variations due to variations in processing conditions, variations in the environment (such as temperature and humidity changes), and aging which can cause slight shifting, elongation, or shrinking of the mold. Stretching can take place using various suitable manual and automated techniques.

Aligning the flexible mold is preferably accomplished by stretching the flexible mold in one or more directions parallel to the plane of the substrate until the desired registry is achieved.

For example, electrodes are often provided on a glass panel in a pattern of parallel lines. The microstructured surface of the mold typically comprises a plurality of depressions that create a parallel rib pattern, grid (i.e. lattice) pattern, or other pattern. With reference to a mold that creates a parallel rib, the mold may be stretched in a direction, either parallel to the substrate pattern or perpendicular to the substrate pattern, depending on whether the pitch of the mold is greater than or less than the pitch of the substrate pattern. FIG. 2 shows the case where mold 200 is stretched in a direction parallel to the parallel barrier rib pattern of the substrate 234. In this case, the pitch of the pattern of the mold is reduced during stretching to conform it to the pitch of the pattern of the substrate. To expand the pitch of the mold, the mold is stretched in the perpendicular direction.

As illustrated in FIG. 2, when a polymeric microstructured mold is uniformly stretched, it is common for the center portion of the mold to narrow. This is referred to as “necking”. Due to necking, the area of the mold that has actually been properly aligned may be substantially reduced. Uniformly stretching in two axes (i.e. x-axis and y-axis) reduces necking to some extent. However, the area that is uniformly stretched is only a fraction of the total microstructured surface area.

Presently described are methods of aligning the microstructured surface of a mold that increases the useful aligned mold surface area.

In one embodiment, necking of a polymeric microstructured mold can be reduced or substantially eliminated by employing a segmented mold. A segmented mold comprises relief regions preferably at the periphery of a center mold region. The relief regions provide locations of weakness that are capable of reducing stress during stretching of the mold. Although it is typically preferred to provide relief regions along the entire peripheral edge of a discrete mold or along the entire periphery of a center region of for example a continuous roll of molds, relief regions may alternatively only be provided along one or two (e.g. orthogonal or parallel) peripheral edges.

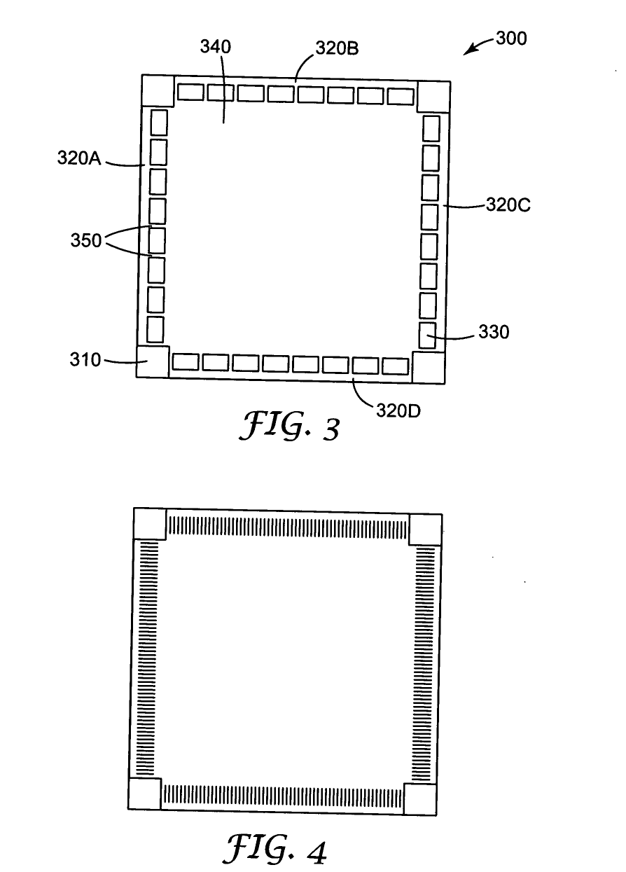

In one aspect, relief regions can conveniently be created by forming voided areas at the periphery of a center mold region as depicted in FIG. 3. The voided areas may have various shapes including for example triangles, circle and squares. In another aspect, relief regions can be created by cutting slits in the periphery as depicted in FIG. 4. As an alternative to forming relief regions by cutting through the periphery portion of a center mold region, the relief regions may merely have a substantially reduced thickness (e.g. 1/10th the thickness of the non-relief regions of the mold). Relief regions of reduced thickness can be formed for example by chemical etching or machining of a preformed mold. Alternatively, the flexible segmented mold can be molded from a master mold or transfer mold including the relief regions.

The segmented mold may have a single row of relief regions as shown in FIGS. 3 and 4. Alternatively, two or more rows of relief regions may be formed. For example, a first row may be off-set from an adjacent second row. The relief regions may be the same or may vary in size and shape. Various combinations of sizes and types of relief regions may be created.

The mold may have at least two, at least three, etc. relief regions disposed between the clamping edge region and center mold region. Typically, the mold will have at least one relief region on each opposing side forming at least four segments. To simplify the mathematical modeling, the arrangement (e.g. number per area and dimensions) of relief regions on one side of (e.g. a rectangular or square) mold are typically the same as the opposing side. In the case of circular shaped molds, the relief regions are typically arranged evenly along the circumference.

The uniformity of the displacements is related to the spacing and width of the continuous regions. A greater number of continuous regions per peripheral linear area (i.e. created by adjacent relief regions) increases the uniformity. The relief regions are typically at least 5 mm apart and may be spaced 50 mm to 100 mm apart. Although the mold sheet can be created with relief regions that have a width of zero for example by making a slit, some width to the relief regions may prevent adjacent continuous mold regions from affecting each other. The width (i.e. a dimension parallel to the peripheral edge) of the relief regions is typically at least about 1 mm and may be as much as 10 mm (for molds suitable for making a single display panel).

With reference to FIG. 3, an exemplary segmented mold 300 can be created from a 10 mm thick polycarbonate sheet having a surface area of 1 m². Square shaped portions (92.5 mm by 92.5 mm) 310 having corner radii, can be cut away from each of the corners of the mold to eliminate high stresses at the corners, provide clearance between adjacent clamping regions, and simplify the mathematical modeling. Such cut away portions may have various other shapes such as triangular shapes or a diagonal slit. This separates the mold into four edge clamp regions, 320a-320d. The edge clamping regions, 320, can measure for example 25 mm in width by ×815 mm in length. Each relief region 330 preferably has corner radii, of for example 2 mm, to prevent stress concentration and tearing at the corners. The relief regions are disposed between the edge clamping region and the center mold portion 340 (e.g. 800 mm by 800 mm). The relief regions can have a width of 50 mm and a length (i.e. dimension perpendicular to the peripheral edge) of 85 mm. Each relief region is typically bound by continuous mold regions (e.g. 50 mm wide by 15 mm in length) that extend from and/or connect center mold region 340 to edge clamp regions 320.

With reference to FIG. 4, another exemplary segmented mold may have 1 mm by 50 mm relief regions spaced at 10 mm intervals about the entire periphery portion of the mold.

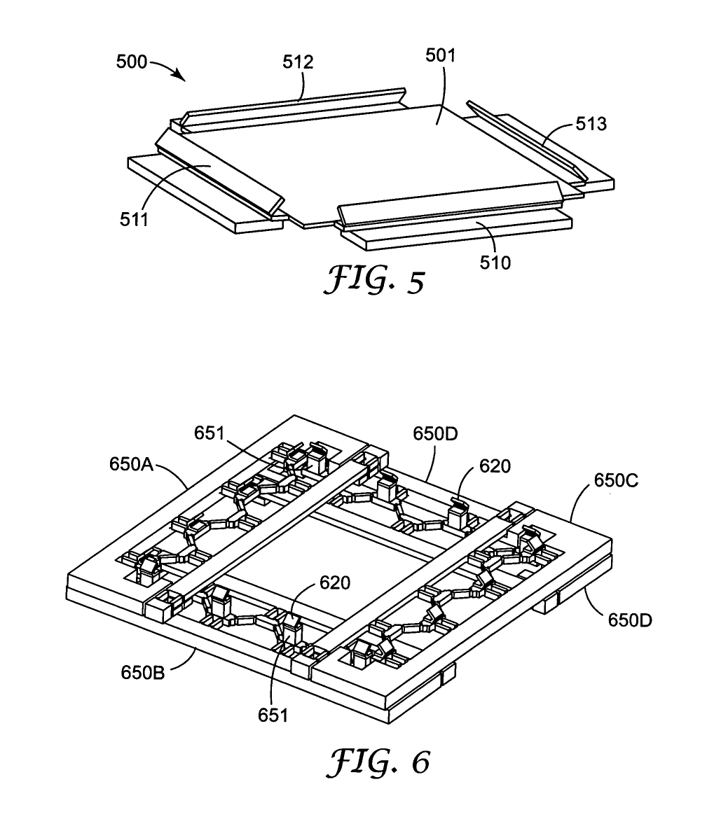

With reference to FIG. 5, the segmented mold may be stretched by means of an exemplary frame apparatus suitable for aligning a flexible mold. The apparatus 500 includes an alignment device that includes a flat plate 501 and four continuous clamps, 510, 511, 512, and 513. The flat plate 501 may consist of stainless steel having a thickness of about 5 mm with a 16 micro-inch surface finish. The flat plate along with the underlying support structure provides sufficient rigidity to prevent motion of the top surface of the flat plate. The continuous clamps are provided on all four side of a discrete flexible mold. Depending of the shape of the mold each continuous clamp typically spans 50% to 100% of the length of a single edge of the mold. For example, in the case of quadrilateral shaped mold, each continuous clamp typically spans about 85% of the length of one edge of a mold sheet. This apparatus is suitable for stretching the mold in an axis parallel to the barrier ribs and in an axis perpendicular (i.e. orthogonal) either sequentially or concurrently. The apparatus also preferably comprises feedback devices (not shown) and a central processing system (computer, also not shown) to coordinate the stretching.

A patterned reference substrate (e.g. electrode patterned glass panel) may be positioned on the flat plate. Alternatively, an image of the patterned reference substrate or merely the electronic coordinates of a model reference substrate may be stored in a computer.

During an embodied method, the continuous clamps are opened. A flexible segmented mold is placed on the flat plate, preferably unstressed (i.e. with no external forces on it). The edges of the mold sheet are placed within the jaw of the open clamps. The clamps are closed, gripping a major portion of each opposing edge of the mold sheet. Although the applied force could be applied by manual means, preferably an automated system is employed that utilizes a visual feedback system to monitor the location of fiducials on the flexible mold while controlling the movement of the continuous clamps in response to the monitoring of the fiducials. The mold is then stretched such that the microstructures of the microstructured surface are aligned with a patterned reference substrate, image thereof, or model reference substrate.

The mold sheet is stretched by means of a force applied to at least two of the continuous clamps such that the mold is stretched in a first direction and a second direction, substantially orthogonal to the first direction. In doing, the continuous portions between the relief regions of the segmented mold (e.g. 350 of FIG. 3) transfer the stretching force from the edge clamp region to the center molding regions. This results in the center mold region being stretched uniformly in both the X-axis and Y-axis.

A finite element analysis was applied to the exemplary segmented mold of FIG. 3, where each clamping region was moved by 5 mm. The X and Y displacements were found to be very uniform. A nominal stretch of 50μ in both the X axis and Y axis could adjust the pitch of a segmented mold having a pitch that is nominally 0.005% too short in both axes. By use of a segmented mold the area of uniform stretch is substantially the entire center molding region.

A preferred approach to reducing necking comprises independently aligning (e.g. by stretching) one microstructured surface portion of a mold relative to a different microstructured surface portion of the mold. Independently aligning refers to adjusting one portion of the mold by a different magnitude and/or a different direction (e.g. x, y coordinates) related to a different portion of the mold. This can be accomplished by means of a segmented frame apparatus. The segmented frame apparatus can be used alone or in combination with the segmented mold. As used herein, “frame” refers to a support structure provided on at least about 80% of the periphery of a (e.g. discrete) mold. As used herein, “apparatus” refers to a machine or component thereof. The discrete mold typically corresponds in dimensions to a single display panel (e.g. has a length and width from about 1 cm² to about 2 m²). Providing a discrete mold in a frame apparatus advantageously provides an improved means of support for the flexible mold during alignment via stretching. The frame may have most any shape. Although rectangular shaped frames are most common, the frame may alternatively be polygonal (e.g. square) or circular for example.

In one aspect, a segmented frame apparatus can be created for example by attaching individual clamps to the periphery of a segmented or unsegmented mold sheet. Independently stretching a portion of the mold relative to a different portion substantially increases the useful microstructured surface area in the center mold region. For example, applying a finite element analysis to a 1000 mm by 1500 m mold stretched by 5 mm with a frame apparatus having 21 evenly distributed (e.g. point) clamps on each side results in 1505 mm×1005 mm area center mold region having a deviation of less than 1μ from the desired positions.

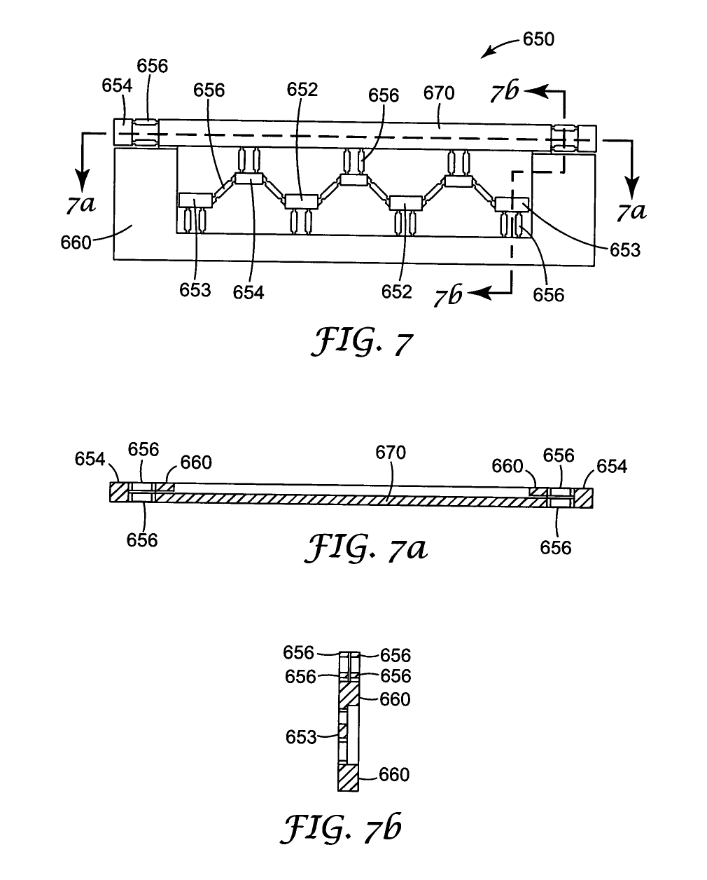

FIGS. 6 and 7 depict another exemplary segmented frame apparatus. Segmented frame apparatus 600 can be created from (e.g. four) clamp moving flexures 650A-650D. A detailed planar view of the clamp moving flexures is depicted in FIG. 7. Clamp moving flexures 650B and 650D are positioned beneath and orthogonal to clamp moving flexures 650A and 650C. Each of the clamp moving flexures has clamps 620 mounted to its (e.g. four) moving pads 652. Clamp spacers, 651, position the clamps from two of the clamp moving flexures, 650B and 650D, into a common plane with the clamps of the remaining two clamp moving flexures, 650A and 650D. The clamp moving flexures are all attached to a common framework (not shown) by two linear positioning devices (not shown) moveable along each clamp moving flexure's center axis 680. These two inputs allow the spacing and position of the clamps relative to the common framework to be adjusted based on feedback (e.g. vision system). The common framework can be moved to integrate the segmented frame apparatus with other processes (e.g. laminating, bonding to a rigid support). During use the edges of the microstructured mold are held by the clamps of the clamp moving flexures.

The clamp moving flexures 650 may be formed from a solid block of aluminum machined to form moving pads 652 and 653, (e.g. five) spacing pads 654, a positioning base 660, a spreading base 670, and (e.g. twenty-eight) pivot pads 656. The pivot pads function as a link with a rotary bearing at each end. Circular hinge flexure elements at each end that elastically deform to allow rotation. The centerline of the clamp moving flexure is defined by the axis 680. The mechanism of the clamp moving flexures function such that when the spreading base is moved relative to the positioning base along the centerline, the spacing of the moving pads changes such that the innermost moving pads 652 move an equal distance away from the centerline, and the outermost moving pads 653 that are three times farther from the centerline move three times farther than the innermost pads. This allows the position of the moving pads normal to the centerline to be controlled accurately by a single input to achieve the desired (e.g. pitch) alignment of the microstructured surface of the mold. The flexure design constrains the motion of the spreading base relative to the positioning base along the centerline, and the motion of the moving pads parallel and normal to the centerline. All motion is also constrained to single plane parallel to the microstructured mold. A similar mechanism may be built from many links and rotary or linear bearings. However, the flexure design does not have any bearing slop making it more accurate, and all mechanism adjustments are machined into the mechanism during its creation simplifying its use and minimizing maintenance.

During use, a rectangular microstructured flexible mold of initial size Xₛₕ by Yₛₕ can be held by clamps along the peripheral edges of the mold. The origin coordinates (0,0) are at the center of the sheet. The x-axis is parallel to the top and bottom edges; whereas the y-axis is parallel to the left and right side. The coordinates of any clamp on the top edge or bottom edge before stretching is

$$( {X}_{c} , \pm \frac{{Y}_{sh}}{2} ) .$$

Clamps on the left edge or right edge have coordinates

$$( \pm \frac{{X}_{sh}}{2} , {Y}_{c} ) .$$

The pitch of the X and Y features on the flexible mold sheet can be adjusted by increasing the overall dimensions of the sheet by ΔX, ΔY. To achieve this, the location of each clamp on the top and bottom edges can be moved by the segmented apparatus from its original coordinates to coordinates

$$( {X}_{c} [ 1 + \frac{2 \cdot Δ X}{{X}_{sh}} ] , \pm [ \frac{{Y}_{sh} + Δ Y}{2} ] ) .$$

Further the location of each clamps on the left or right edges can be moved from its original coordinates to coordinates.

$$( \pm [ \frac{{X}_{sh} + Δ X}{2} ] , {Y}_{c} [ 1 + \frac{2 \cdot Δ Y}{{Y}_{sh}} ] )$$

A linear motor and encoder system, not shown, controls the position of both the positioning base and spreading base of each clamp moving flexure along its centerline. A central computer control system, not shown, can adjust the position of all eight of the linear motors based on feedback from a vision system that monitors the location of fiducials on the sheet being stretched.

Other means of stretching polymeric sheet materials that may be suitable in the method of the invention are described in U.S. Pat. Nos. 5,162,008 and 5,534,969; incorporated herein by reference.

After the mold has been properly aligned, a rigid support may be attached to the aligned mold sheet to maintain the alignment such as describe in concurrently filed U.S. patent application Attorney Docket No. 60591US002; incorporated herein by reference. Alternatively, the mold attached to a frame apparatus may be employed in the method of molding (e.g. barrier rib) microstructures. The mold attached to the frame may be contacted with a slurry coated glass panel by use of a planar transfer assembly under vacuum as known in the art.

The microstructured flexible (e.g. unaligned) mold is preferably formed according to a process similar to the processes disclosed in U.S. Pat. No. 5,175,030 (Lu et al.) and U.S. Pat. No. 5,183,597 (Lu). The formation process preferably includes the following steps: (a) preparing an oligomeric resin composition; (b) depositing the oligomeric resin composition onto a master negative microstructured tooling surface in an amount barely sufficient to fill the cavities of the master; (c) filling the cavities by moving a bead of the composition between a preformed substrate and the master, at least one of which is flexible; and (d) curing the oligomeric composition. A preferred master is a metallic tool. If the temperature of the curing and optional simultaneous heat treating step is not too great, the master can also be constructed from a thermoplastic material, such as a laminate of polyethylene and polypropylene. Alternatively, a glass master may be used.

The oligomeric resin composition of step (a) preferably is a one-part, solvent-free, (e.g. radiation polymerizable) crosslinkable, organic oligomeric composition. The oligomeric composition is preferably curable to form a flexible and dimensionally-stable cured polymer. The curing of the oligomeric resin preferably occurs with low shrinkage. The Brookfield viscosity of the oligomeric resin is typically at least 10 cps and typically no greater than 35,000 cps and more preferably has a viscosity in the range of 50 cps to 10,000 cps.

Preferred oligomeric compositions comprise at least one acryl oligomer and at least one acryl monomer such as described in oligomeric resin compositions are described in PCT application no. US04/26845 filed Aug. 18, 2004; PCT Publication No. WO2005/021260 and U.S. patent application Ser. No. 11/107,554, filed Apr. 15, 2005; each of which are incorporated herein by reference.

Polymerization can be accomplished by typical means, such as heating in the presence of free radical initiators, irradiation with ultraviolet or visible light in the presence of suitable photoinitiators, and by irradiation with electron beam. For reasons of convenience, low capital investment, and production speed, the preferred method of polymerization is by irradiation with ultraviolet or visible light in the presence of photoinitiator at a concentration of about 0.1 percent to about 1.0 percent by weight of the oligomeric resin composition. Higher concentrations can be used but are not normally needed to obtain the desired cured resin properties.

Various materials can be used for the base (substrate) of the flexible mold. Typically the material is substantially optically clear to the curing radiation and has enough strength to allow handling during casting of the microstructure. In addition, the material used for the base can be chosen so that it has sufficient thermal stability during processing and use of the mold. Polyethylene terephthalate or polycarbonate films are preferable for use as a substrate in step (c) because the materials are economical, optically transparent to curing radiation, and have good tensile strength. Substrate thicknesses of 0.025 millimeters to 0.5 millimeters are preferred and thicknesses of 0.075 millimeters to 0.175 millimeters are especially preferred. Other useful substrates for the microstructured mold include cellulose acetate butyrate, cellulose acetate propionate, polyether sulfone, polymethyl methacrylate, polyurethane, polyester, and polyvinyl chloride. The surface of the substrate may also be treated to promote adhesion to the oligomeric composition.

Examples of suitable polyethylene terephthalate based materials include photograde polyethylene terephthalate; and polyethylene terephthalate (PET) having a surface that is formed according to the method described in U.S. Pat. No. 4,340,276, incorporated herein by reference.

The hardness of the base mold substrate (e.g. plastic film) can be expressed by rigidity against tension, for example, or by tensile strength. The tensile strength of the base mold substrate is generally at least about 5 kg/mm² and preferably at least about 10 kg/mm². When the tensile strength of the base mold substrate is lower than 5 kg/mm², handling property drops when the resulting mold is released from the mold or when the PDP ribs are released from the mold, so that breakage and tear are likely to occur. However, a lower strength mold base substrate may be utilized in view of the strength provided by the rigid support.

The aligned mold described herein can be used in various known methods as described in the art. The method generally comprises providing a curable material between the microstructured surface of the mold and an electrode patterned glass panel, curing the paste; and removing the mold. The mold is typically transparent. The paste may be cured through the glass panel, though the mold, through the support, or a combination thereof.

A suitable curable material for forming the microstructures can be placed between the mold and the patterned substrate (e.g. glass panel) in a variety of ways. The material can be placed directly in the pattern of the mold followed by placing the mold and material on the substrate, the material can be placed on the substrate followed by pressing the mold against the material on the substrate, or the material can be introduced into a gap between the mold and the substrate as the mold and substrate are brought together by mechanical or other means. Regardless of the manner employed, care should be taken minimize entrapment of air.

The molding material is preferably a slurry or paste containing a mixture of at least three components. The first component is a ceramic powder. The ceramic material of the slurry will ultimately be fused or sintered by firing to form microstructures having desired physical properties adhered to the patterned substrate. The second component is a fugitive binder that is capable of being shaped and subsequently hardened by curing or cooling. The binder allows the slurry to be shaped into semi-rigid green state microstructures that are adhered to the substrate so that the stretchable mold used to form and align the microstructures can be removed in preparation for debinding and firing. The third component is a diluent that can promote release from the mold after alignment and hardening of the binder material, and can promote fast and complete burn out of the binder during debinding before firing the ceramic material of the microstructures. The diluent preferably remains a liquid after the binder is hardened so that the diluent phase-separates from the binder material during binder hardening. Various paste compositions are known and described for example in U.S. patent application Ser. No. 11/107,608, filed Apr. 15, 2005 and PCT Publication WO2005/019934; each of which are incorporated herein by reference.

Various other aspects that may be utilized in the invention described herein are known in the art including, but not limited to each of the following patents that are incorporated herein by reference: U.S. Pat. No. 6,247,986; U.S. Pat. No. 6,537,645; U.S. Pat. No. 6,713,526; WO 00/58990, U.S. Pat. No. 6,306,948; WO 99/60446; WO 2004/062870; WO 2004/007166; WO 03/032354; WO 03/032353; WO 2004/010452; WO 2004/064104; U.S. Pat. No. 6,761,607; U.S. Pat. No. 6,821,178; WO 2004/043664; WO 2004/062870; PCT Application No. US04/33170, filed Oct. 8, 2004; PCT Application No. US04/26701, filed Aug. 17, 2004; PCT Application No. US04/26845, filed Aug. 18, 2004; PCT Application No. US04/23472 filed Jul. 21, 2004; PCT Application No. US04/32801 filed Oct. 6, 2004; PCT Application No. US04/43471 filed Dec. 22, 2004; U.S. Patent Application Ser. Nos. 60/604,556, 60/604,557, 60/604,558 and 60/604,559, each filed 8-26-04.

What is claimed is:

1. A method of aligning a mold comprising:
providing a flexible mold having a microstructured surface; and
independently stretching one portion of the mold relative to a different portion of the mold to substantially align the microstructured surface.

2. The method of claim 1 wherein the mold is stretched in a first axis and a second axis, substantially orthogonal to the first axis.

3. The method of claim 1 wherein the stretching is accomplished by means of a segmented frame apparatus.

4. The method of claim 1 wherein the mold prior to being aligned has a positioning error of 10 ppm to 1000 ppm.

5. The method of claim 1 wherein the aligned mold has a positioning error of less than 10 ppm after stretching.

6. The method of claim 1 wherein the mold is substantially aligned with a patterned substrate.

7. A method of making a microstructured article comprising
providing the aligned mold of claim 1;
placing a curable material between the microstructured surface of the mold and the patterned substrate either prior to or after stretching the mold;
curing the curable material; and
removing the mold.

8. The method of claim 8 wherein the mold is transparent.

9. The method of claim 8 wherein the curable material is radiation cured through the patterned substrate, though the mold, or a combination thereof.

10. The method of claim 1 wherein the mold corresponds in size to a single display panel.

11. The method of claim 10 wherein the mold has an areas ranging from about 1 cm² to about 2 m².

12. The method of claim 1 wherein the mold is a portion of a sheet or roll.

13. The method of claim 1 wherein the mold comprises at least one polymeric material.

14. A method of aligning a mold comprising:
providing a flexible mold having a microstructured surface in an apparatus wherein the mold, the apparatus, or combination thereof comprises relief regions; and
stretching the mold by means of the apparatus to substantially align the microstructured surface.

15. The method of claim 14 wherein the mold is substantially free of necking in the center mold region during stretching.

16. A frame apparatus attached to at least two peripheral portions of a center mold region of a microstructured mold wherein the frame apparatus comprises segments and one segment can move independently relative to a different segment.

17. The frame apparatus of claim 16 wherein the first peripheral portion is parallel or orthogonal to the second peripheral portion.

18. The frame apparatus of claim 16 wherein the frame apparatus comprises at least one segment per 100 mm to 500 mm of periphery.

19. A segmented mold comprised of a polymeric material, having at least one microstructured surface and a plurality of relief regions.

20. The segmented mold of claim 19 wherein the relief regions are provided at peripheral portions of a center mold region.

21. The segmented mold of claim 19 wherein relief regions comprise voided areas, slits, areas of reduced thickness, or combinations thereof.

22. The segmented mold of claim 20 wherein the relief regions are provided in one or more rows.

23. The segmented mold of claim 21 wherein the relief regions vary in size, shape, or combinations thereof.
